(19) United States
(12) Patent Application Publication
(10) Pub. No.: US 2009/0276629 A1
(43) Pub. Date: Nov. 5, 2009

(54) METHOD FOR DERIVING TRAFFIC ENCRYPTION KEY

(75) Inventors: Lin-Yi Wu, Taipei County (TW); Chi-Chen Lee, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/432,866

(22) Filed: Apr. 30, 2009

Related U.S. Application Data
(60) Provisional application No. 61/048,965, filed on Apr. 30, 2008.
(60) Provisional application No. 61/051,819, filed on May 9, 2008.
(60) Provisional application No. 61/053,041, filed on May 14, 2008.

(51) Int. Cl. H04L 9/32; H04K 1/00

(52) U.S. Cl. 713/175; 380/270

(57) ABSTRACT

A mobile station is provided. The mobile station includes one or more radio transceiver module and a processor. The processor generates an Authorization Key (AK) context including at least one secret key shared with a base station, transmits at least one association negotiation message via the radio transceiver module to the base station to obtain an association of a service flow established by the base station, and generates at least one TEK according to the secret key and an identifier associated with the association. The service flow is established for traffic data transmission with the base station and the TEK is a secret key shared with the base station for encrypting and decrypting the traffic data.

### CROSS REFERENCE TO RELATED APPLICATIONS

This application claims the benefit of U.S. Provisional Application No. 61/051,819 filed May 9, 2008 and entitled “TEK UPDATE IN HO”, U.S. Provisional Application No. 61/048,965 filed Apr. 30, 2008 and entitled “KEK AND TEK GENERATION FOR ACCELERATE DATA TRANSFER IN HO”, and U.S. Provisional Application No. 61/053,041 filed May 14, 2008 and entitled “TEK UPDATE IN HO-NEGOTIATION AND CONFIRMATION”. The entire contents of which are hereby incorporated by reference

### BACKGROUND OF THE INVENTION

1. Field of the Invention

The invention relates to a method for deriving a Traffic Encryption Key (TEK).

2. Description of the Related Art

In a wireless communication system, a Base Station (BS) provides services to terminals in a geographical area. The base station usually broadcasts information in the air interface to aid terminals in identifying necessary system information and service configurations so that essential network entry information can be gained and determination of whether to use services provided by the BS may be provided.

In WiMAX (Worldwide Interoperability for Microwave Access) communication systems, or IEEE 802.16-like systems, if data encryption is negotiated between base station and terminal, traffic data is allowed to be transmitted after the TEK is generated. The TEK is a secret key used to encrypt and decrypt the traffic data. The BS randomly generates the TEK, encrypts the TEK by the Key Encryption Key (KEK) and distributes the encrypted TEK to the terminal. The KEK is also a secret key shared between the terminal and the BS. The KEK is derived by the terminal and base station individually according to a predetermined algorithm. After receiving the encrypted TEK from the BS, the terminal decrypts the TEK by the KEK. The terminal encrypts the traffic data by the TEK after obtaining the TEK and transmits the encrypted traffic data to the BS.

Conventionally, during a optimized handover procedure, the target base station generates the TEK after receiving a ranging request message from the terminal, and responds with the encrypted TEK to the terminal via a ranging response message. However, traffic data transmission is inevitably interrupted during the time period after a handover message is sent, and until the TEK is received and decrypted. A long interruption time period seriously degrades the quality of the communication service. Thus, a novel TEK generation method is highly required.

### BRIEF SUMMARY OF THE INVENTION

Mobile Station (MS) and method for deriving a Traffic Encryption Key are provided. An embodiment of a mobile station includes one or more radio transceiver module and a processor. When the authentication and data encryption are negotiated between MS and Base Station (BS), the processor generates an Authorization Key (AK) context including at least one secret key shared with a base station, transmits at least one association negotiation message via the radio transceiver module to the base station to obtain an association of a service flow established by the base station, and generates at least one TEK according to the secret key and an identifier associated with the association. The service flow is established for traffic data transmission with the base station and the TEK is a secret key shared with the base station for encrypting and decrypting the traffic data.

An embodiment of a method for generating at least one Traffic Encryption Key (TEK) for a mobile station and a base station in a wireless communication network, comprises: generating an Authorization Key (AK) context, wherein the AK context comprises at least one secret key shared between the mobile station and base station for protecting at least one message transmitted therebetween; obtaining an association of a service flow established between the mobile station and base station to transmit traffic data therebetween, wherein the association is identified by an identifier; obtaining a number associated with the TEK to be generated; and generating the TEK according to the secret key, the identifier and the number via a predetermined function, wherein the TEK is a secret key shared between the mobile station and the base station for encrypting or decrypting the traffic data.

Another embodiment of a mobile station in a wireless communication network, comprises one or more radio transceiver module and a processor. The processor performs handover negotiation with a serving base station so as to handover communication services to a target base station by transmitting and receiving a plurality of handover negotiation messages via the radio transceiver module, updates a count value, generates an Authorization Key (AK) context comprising a plurality of keys shared with the target base station for protecting messages to be transmitted to the target base station, and transmits the count value to at least one network device in the wireless communication network via the radio transceiver module. The count value is used in AK context generation and capable of distinguishing between different generations of the AK context, and is relayed to the target base station via the network device.

Another embodiment of a base station in a wireless communication network, comprises one or more radio transceiver module and a processor. The processor generates an Authorization Key (AK) context comprising at least one secret key shared with a mobile station, establishes an association of a service flow, obtains a number, and generates at least one Traffic Encryption Key (TEK) according to the secret key, the number and an identifier associated with the association. The service flow is established for traffic data transmission and reception with the mobile station via the radio transceiver. The number is associated with the TEK to distinguish between different generations of the TEK. The TEK is a secret key shared with the mobile station for encrypting and decrypting the traffic data

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows an exemplary network topology of a wireless communication system according to an embodiment of the invention;

FIG. 2 shows a schematic view of a base station according to an embodiment of the invention;

FIG. 3 shows a schematic view of a mobile station according to an embodiment of the invention;

FIG. 4 shows a schematic diagram illustrating an AK context generation procedure according to an embodiment of the invention;

FIG. 5 shows a schematic diagram of a communication network for illustrating the TEK generation concept according to an embodiment of the invention;

FIG. 6 shows a flow chart of a method for generating a TEK for an MS and a BS in a wireless communication network according to an embodiment of the invention;

FIG. 7 shows a flow chart of a method for deriving a TEK for an MS and a BS in an initial network entry procedure according to an embodiment of the invention;

FIG. 8 shows a flow chart of a method for periodically updating a TEK according to an embodiment of the invention;

FIG. 9 a flow chart of a method for deriving a TEK during a handover procedure according to an embodiment of the invention;

FIG. 10 shows a flow chart of a method for deriving a TEK in a re-authentication procedure according to an embodiment of the invention;

FIG. 11 shows the message flows of handover operation procedures according to an embodiment of the invention; and

FIG. 12 shows the message flows of handover operation procedures according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

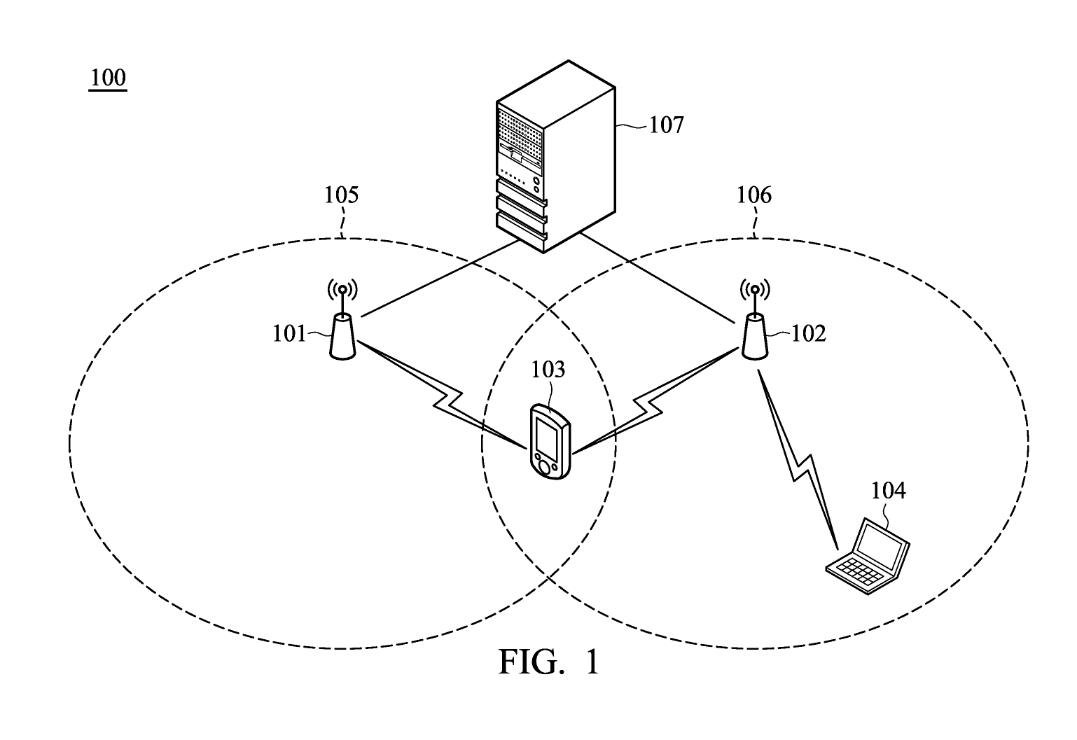

FIG. 1 shows an exemplary network topology of a wireless communication system according to an embodiment of the invention. As shown in FIG. 1, the wireless communication system 100 comprises one or more base stations (BS) 101 and 102 in one or more sectors 105 and 106 that receive, transmit, repeat, etc., wireless communication signals and provide services to each other and/or to one or more mobile stations (MS) 103 and 104. The wireless communication system 100 further comprises one or more network device 107 in the backbone network (also referred as a Core Network (CN)) that communicates with the base stations to provide and maintain services for the base stations. According to an embodiment of the invention, the mobile station may be a mobile phone, a computer, a notebook, a PDA, a CPE . . . etc., and thus, the invention should not be limited thereto. Base stations 101 and 102 may be connected to an infrastructure network (e.g. the Internet) and, therefore, provide connectivity to the Internet. According to one embodiment of the invention, the base stations 101 and 102 may facilitate peer-to-peer communication service (e.g. communication directly between mobile stations 103 and 104). According to the embodiment of the invention, the wireless communication system 100 may be configured as a WIMAX communication system or adopt technologies based on one or more specifications defined in the series of IEEE 802.16 related standards.

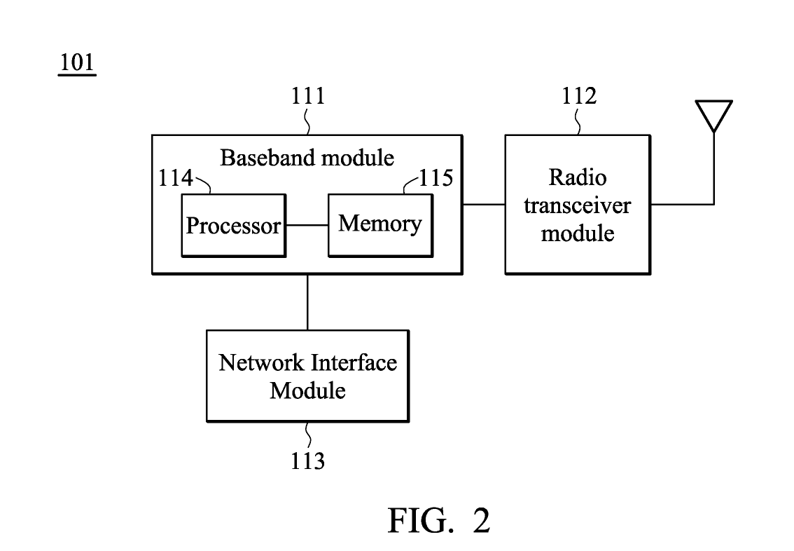

FIG. 2 shows a schematic view of a base station according to an embodiment of the invention. The base station 101 may comprise a baseband module 111, a radio transceiver module 112 and a network interface module 113. The radio transceiver module 112 may comprise an antenna, a receiver chain to receive wireless radio frequency signals and convert the received signals to baseband signals to be processed by the baseband module 111, and a transmitter chain to receive baseband signals from the baseband module 111 and convert the received signals to wireless radio frequency signals to be transmitted to the air interface. The radio transceiver module 112 may comprise a plurality of hardware devices to perform radio frequency conversion. The network interface module 113 is coupled to the baseband module 111 and used to communicate with the network devices in the backbone network, such as the network device 107 as shown in FIG. 1. The baseband module 111 further converts the baseband signals to a plurality of digital signals, and processes the digital signals, and vice versa. The baseband module 111 may also comprise a plurality of hardware devices to perform baseband signal processing. The baseband signal processing may comprise analog to digital conversion (ADC)/digital to analog conversion (DAC), gain adjustments, modulation/demodulation, encoding/decoding, and so on. The baseband module 111 further comprises a processor 114 and a memory 115. In order for the mobile stations 103 and 104 to access base stations 101 and 102 and use the offered services, or to utilize the spectrum for wireless communications, base stations 101 and 102 broadcast certain system information. The memory 115 may store the system information of the base station 101, and further store a plurality of software/firmware code or instructions to provide and maintain the wireless communication services. The processor 114 executes the code and/or instructions stored in the memory 115, and controls the operations of memory 115, the baseband module 111 and the radio transceiver module 112.

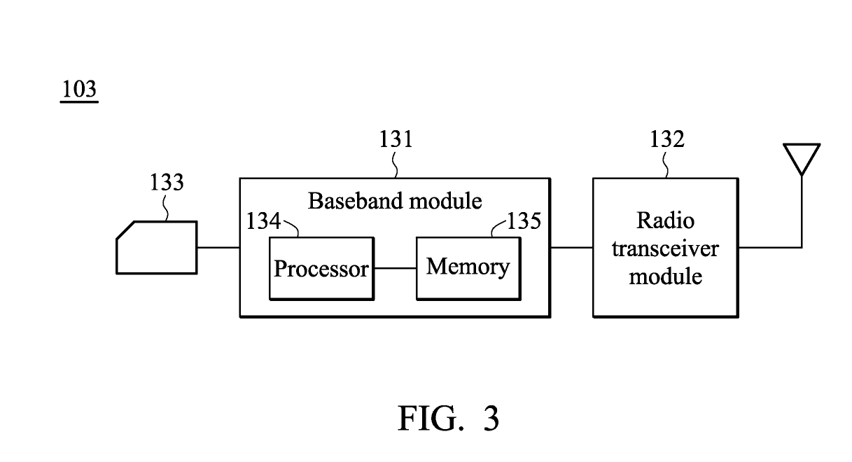

FIG. 3 shows a schematic view of a mobile station according to an embodiment of the invention. The mobile station 103 may comprise a baseband module 131, a radio transceiver module 132 and selectively comprise a subscriber identity card 133. The radio transceiver module 132 receives wireless radio frequency signals, converts the received signals to baseband signals to be processed by the baseband module 131, or receives baseband signals from the baseband module 131 and converts the received signals to wireless radio frequency signals to be transmitted to a peer device. The radio transceiver module 132 may comprise a plurality of hardware devices to perform radio frequency conversion. For example, the radio transceiver module 132 may comprise a mixer to multiply the baseband signals with a carrier oscillated at the radio frequency of the wireless communication system. The baseband module 131 further converts the baseband signals to a plurality of digital signals, and processes the digital signals, and vice versa. The baseband module 131 may also comprise a plurality of hardware devices to perform baseband signal processing. The baseband signal processing may comprise analog to digital conversion (ADC)/digital to analog conversion (DAC), gain adjustments, modulation/demodulation, encoding/decoding, and so on. The baseband module 131 further comprises a memory device 135 and a processor 134. The memory 135 may store a plurality of software/firmware code or instructions to maintain the operation of the mobile station. It is to be noted that the memory device 135 may also be configured outside of the baseband module 131 and the invention should not be limited thereto. The processor 134 executes code or the instructions stored in the memory 135 and controls the operations of the baseband module 131, the radio transceiver module 132, and the plugged subscriber identity card 133, respectively. The processor 134 may read data from the plugged subscriber identity card 133 and writes data to the plugged subscriber identity card 133. It is also to be noted that the mobile station 103 may also comprise other types of identity module instead of the subscriber identity card 133 and the invention should not be limited thereto.

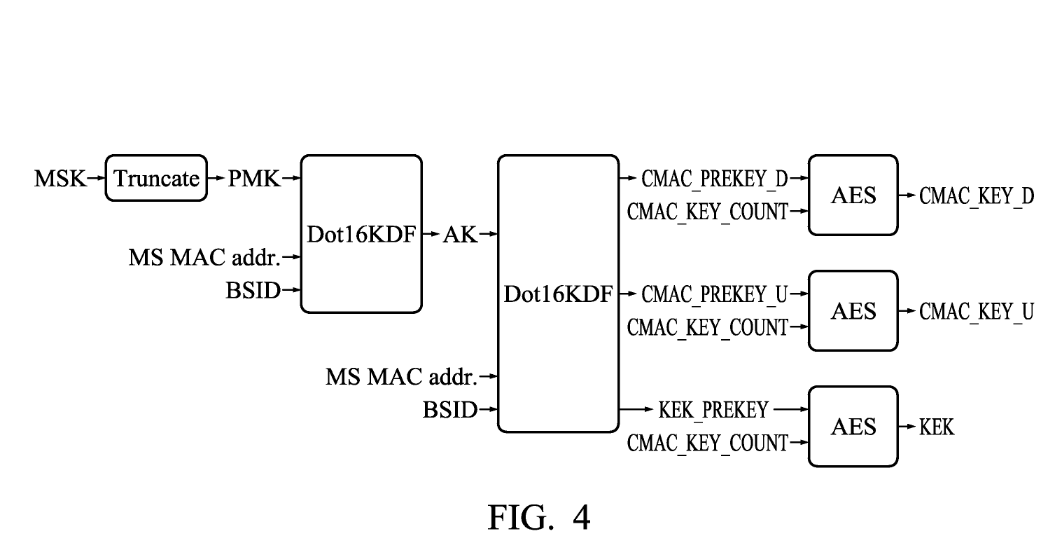

In accordance with protocols defined by WiMAX standards, including IEEE 802.16, 802.16d, 802.16e, 802.16m, and the likes, the base station (BS) and the terminal (also referred to as the Mobile Station (MS)) identify communication parties through an authentication procedure. As an example, the procedure may be done by Extensible Authentication Protocol based (EAP-based) authentication. After authentication, an Authorization Key (AK) context is derived by the MS and BS, respectively, so as to be used as a shared secret in encryption and integrity protection. The AK context comprises a plurality of secret keys for message integrity protection. FIG. 4 shows a schematic diagram illustrating an AK context generation procedure according to an embodiment of the invention. A Master Session Key (MSK) is firstly generated via the EAP-based authentication. The MSK is an unique key shared between the MS and BS to identify the integrity of the MS for the BS. The MSK is truncated to generate the Pairwise Master Key (PMK), and the Authorization Key (AK) is then generated via the Dot16KDF operation according to the PMK, MS Media Access Control layer (MAC) address and the Base Station Identifier (BSID). Three pre-keys CMAC_PREKEY_D, CMAC_PREKEY_U and KEK_PREKEY are then generated via the Dot16KDF operation according to the AK, MS MAC address and the BSID. Finally, the keys CMAC_KEY_U, CMAC_KEY_D and Key Encryption Key (KEK) are generated via the Advanced Encryption Standard (AES) operation according to the pre-keys CMAC_PREKEY_D, CMAC_PREKEY_U, KEK_PREKEY and a count value CMAC_KEY_COUNT, respectively. The keys CMAC_KEY_U are CMAC_KEY_D are message authentication keys for protecting the integrity of uplink and downlink management message, and according to the embodiment of the invention, the KEK is also a secret key shared between the MS and the BS for further deriving the TEK. According to the embodiment, instead of directly outputting the KEK from the Dot16KDF operation in the conventional AK context generation, the KEK is generated according to the CMAC_KEY_COUNT. The count value CMAC_KEY_COUNT may be incremented every time when generating the AK context in the reentry procedure so as to distinguish between different generations of message authentication keys in the AK context. Thus, the count value CMAC_KEY_COUNT may be used to differentiate new Cipher-based Message Authentication Code (CMAC) keys from the old ones.

In the WiMAX communication system, the BS is capable of establishing multiple service flows for the MS. In order to protect the traffic data transmission in each service flow, one or more Security Association (SA) is negotiated between the MS and the BS after network entry. An SA is identified by an SA identifier (SAID) and describes the cryptographic algorithms used to encrypt and decrypt the data traffic. As an example, the SA may be negotiated in an SA-TEK 3-way handshake stage. The MS may inform the BS of its capabilities in a request message SA-TEK-REQ, and the SA (including the SAID) established by the BS may be carried in a response message SA-TEK-RSP so as to be transmitted to the MS. It is noted that the MS may also obtain the SA in other specific ways as known by persons with ordinary skill in the art and the invention should not be limited thereto. For each SA, one or more Traffic Encryption Key (TEK) is generated and shared between the MS and the BS to be the encryption and decryption key in the cryptographic function. In IEEE 802.16e, the TEKs are randomly generated by the BS, and distributed to the MS in a secure way. However, for each TEK update, two management messages are required to be transmitted for distributing the key TEK generated by the BS, which causes a waste of transmission bandwidth. Furthermore, as previously stated, when performing a handover procedure, the traffic data transmission is inevitably interrupted during the time period after a handover request message is sent and until the new TEK is received and decrypted from target base station, wherein the long interrupted time period seriously degrades the quality of the communication service. Thus, according to the embodiments of the invention, a novel TEK generation method is provided. Based on the proposed TEK generation method, the MS and BS may periodically update the TEKs, respectively, without key distribution therebetween. Furthermore, when performing the handover procedure and a re-authentication procedure, the MS and BS may also derive new TEKs, respectively, without key distribution therebetween.

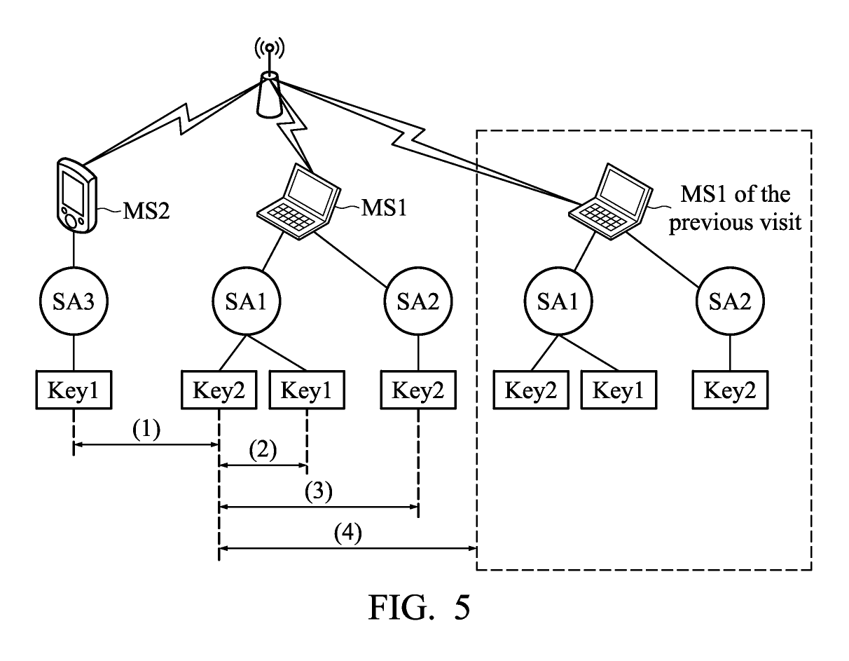

According to the embodiment of the invention, the TEKs may be generated according to a TEK derivation function to guarantee the uniqueness of the TEKs. FIG. 5 shows a schematic diagram of a communication network for illustrating the TEK generation concept according to an embodiment of the invention. In order to guarantee the uniqueness of the TEKs, it is preferable to make sure that the newly derived TEKs are different from (1) the TEKs of the other MSs connected to the same BS, (2) the previous TEKs of the same SA in the same MS, (3) the TEKs of the other SAs in the same MS, and (4) the TEKs of the same SA in the same MS in the previous visit to the BS. According to an embodiment of the invention, to achieve the four requirements described above, the TEK is preferably derived according to the secret key shared between the MS and the BS and the information known by the MS and the BS.

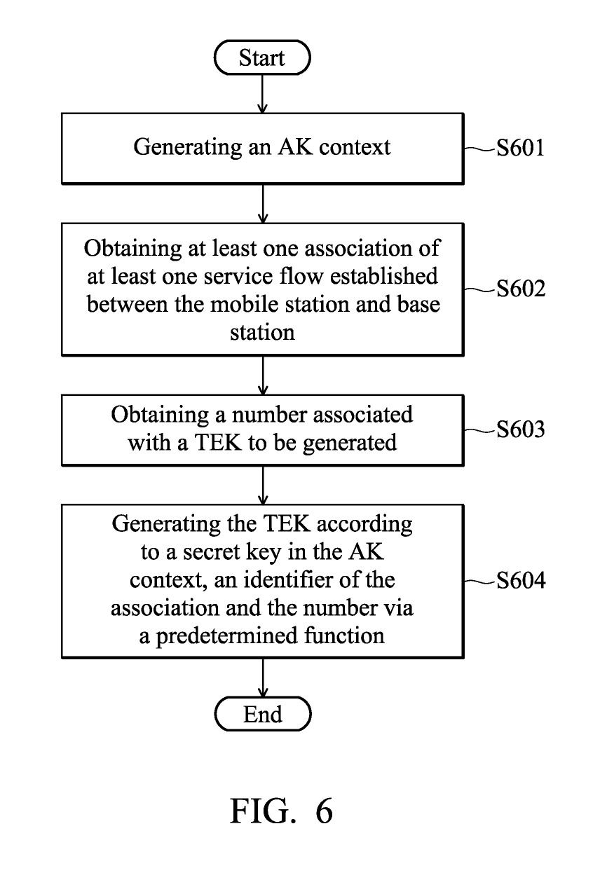

FIG. 6 shows a flow chart of a method for generating a TEK for an MS and a BS in a wireless communication network according to an embodiment of the invention. Firstly, the MS and/or the BS generate an AK context according to the procedure shown in FIG. 4 (Step S601). Next, the MS and/or the BS obtain at least one association of at least one service flow established therebetween (Step S602). Next, the MS and/or the BS obtain a number associated with the TEK to be generated (Step S603). According to an embodiment of the invention, the number associated with the TEK is a number capable of distinguishing between different generations of the TEKs (will be described in detail in the following paragraphs). Finally, the MS and/or the BS generate the TEK according to a secret key in the AK context, an identifier of the association and the number via a predetermined function (Step S604). It is noted that step S602, S603 and S604 may be repeated if there is more than one association. According to an embodiment of the invention, as an example, the secret key may be the KEK, the association may be the SA for the established service flow, and the identifier may be the SAID as previously described. As an example, according to the embodiment of the invention, the TEK derivation may be designed as:

TEK=Function(KEK, TEK_No, SAID) Eq. 1.

According to the embodiment of the invention, the number TEK_No may be maintained by the MS and the BS and may be reset to 0 when an SA is established or after handover. The MS and the BS may maintain the TEK_No by incrementing the TEK_No by one for each TEK periodical update and MS re-authentication.

The function as introduced in Eq. 1 uses the input parameters KEK, TEK_No and SAID to generate new TEKs. The input parameter KEK derived as shown in FIG. 4 is the secret key shared between the BS and MS. Since the KEK of a specific MS is different from the KEKs of the other MSs connecting to the same BS, the KEK may be used to distinguish between different mobile stations connecting to the base station, so as to guarantee that at a time, the TEKs are different between different MSs in the same BS (for the requirement (1) shown in the FIG. 5). Moreover, since the input parameter TEK_No may be incremented every time when the TEK is updated as previously described, the TEK_No may be used to distinguish between different generations of the TEK of the same SA in the same MS, so as to guarantee that for an SA, the newly generated TEK is different from the old TEKs (for the requirement (2) shown in the FIG. 5). Moreover, since the SAID is an identifier of an SA established by the base station for the mobile station and corresponding to the TEK, the SAID may be used to distinguish between the TEKs of the different SAs in the same MS, so as to guarantee that the MS has different TEKs for different SAs (for the requirement (3) shown in the FIG. 5). Moreover, the KEK may also be used to guarantee that the derived TEK is different from TEKs of the same SA in the same MS in the previous visit to the BS (for the requirement (4) shown in the FIG. 5). As previously described, the count value CMAC_KEY_COUNT is a value that may be used to differentiate new CMAC keys from older ones. Since the KEK is generated according to the count value CMAC_KEY_COUNT as shown in FIG. 4, the KEK may further be used to guarantee that for an MS, the TEKs are different in each handover to a BS, even if the BS has been visited during the AK lifetime as defined by the corresponding standards. As an example, everytime when the MS moves from a location covered by a serving BS to a location covered by a target BS and performs handover to transfer the communication services from the serving BS to the target BS, the count value CMAC_KEY_COUNT is incremented for the new generation of the keys in the AK context as illustrated above so as to assure the freshness of the keys.

According to the embodiment of the invention, since the parameters KEK, TEK_No and SAID may all be obtained and/or maintained by the MS and the BS, the TEKs may be easily derived by the MS and the BS without key distribution after an SA is established. According to an embodiment of the invention, the TEK derivation function may use the KEK as the encryption key, and use the rest of the input parameters as the plaintext data in a cryptographic function. The cryptographic function may be an AES_ECB (AES Electronic Code Book mode), 3DES (Data Encryption Standard), IDEA (International Data Encryption Algorithm) . . . etc. As an example, the TEK derivation function may be expressed as:

TEK=AES_ECB(KEK, SAID|TEK_No) Eq. 2 ,

where the operation “|” represents the appending operation to append a following parameter to the tail of the pervious one. According to another embodiment of the invention, the TEK derivation function may also be expressed as:

TEK=3DES_EDE(KEK, SAID|TEK_No) Eq. 3

According to yet another embodiment of the invention, the cryptographic function may also be the cryptographic function Dot16KDF as adopted by the WiMAX standards and the TEK derivation function may be expressed as:

TEK=Dot16KDF(KEK, SAID|TEK_No, 128) Eq. 4

It should be noted that any cryptographic functions achieving substantially the same encryption results may also be applied here and thus, the invention should not be limited thereto.

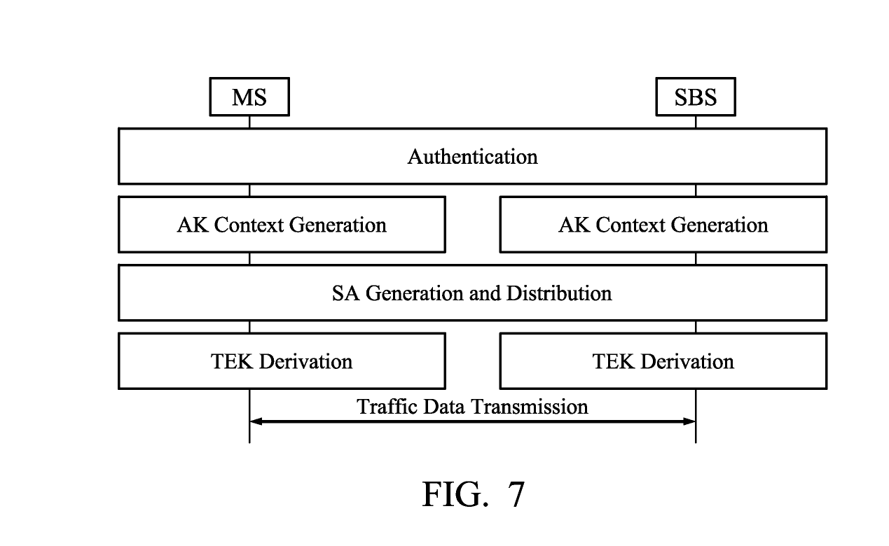

FIG. 7 shows a flow chart of a method for deriving a TEK for an MS and a BS in an initial network entry procedure according to an embodiment of the invention. In the initial network entry procedure, an authentication step is performed for the MS to authenticate its identity. The authentication step may be performed by transmitting a plurality of messages between the MS and the Serving Base Station (SBS). After the authentication step, the MS and the SBS may generate AK context, respectively in the AK context generation step. According to an embodiment of the invention, the AK context may be generated as shown in FIG. 4. After the AK context generation step, the SBS may establish service flows for traffic data transmission for the MS, and generate an SA for each service flow. The SBS may further negotiate the SA and distribute the SA to the MS in the SA generation and distribution step. According to an embodiment of the invention, after the SA is established, the MS and SBS may derive the TEKs, respectively. In the embodiment of the invention, the TEKs may be derived according to the method shown in Eq. 1 to Eq. 4, or the likes. It should be noted that for simplicity, only the stages and the procedures involved by the proposed method and procedures will be discussed. For persons with ordinary skill in the art, it is easy to derive the non-discussed stages and procedures of FIG. 7, and the invention is not limited thereto. Thus, various alterations and modifications, without departing from the scope and spirit of the invention, may be appropriate. The scope of the present invention shall be defined and protected by the following claims and their equivalents.

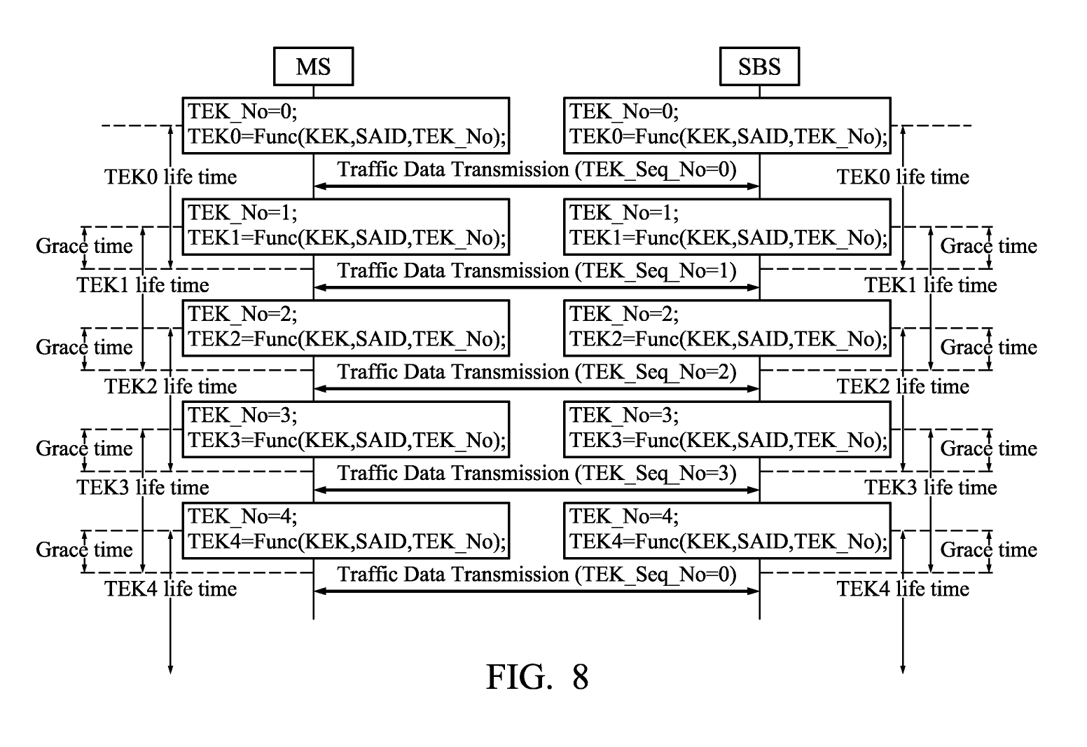

FIG. 8 shows a flow chart of a method for periodically updating a TEK according to an embodiment of the invention. According to the embodiment of the invention, the number TEK_No may be set to 0 by the MS and the SBS when the first TEK TEK0 is derived. At the grace time before the lifetime of the TEK0 expires, the number TEK_No may be incremented by one and a second TEK TEK1 may be derived. During the grace time, the traffic data may be encrypted by the TEK0 or the TEK1 and the MS and the SBS have the ability to decrypt the protocol data units (PDUs) by the TEK0 or the TEK1. A TEK sequence number TEK_Seq_No may be carried in each PDUs to differentiate the new TEK from the older one. According to an embodiment of the invention, the TEK sequence number TEK_Seq_No may be obtained via the modulo operation as:

TEK_Seq_No=TEK_No mod 4 Eq. 5 ,

where the reason why the TEK_No is mod 4, is because the sequence number TEK_Seq_No is represented by two bits in the embodiment of the invention. It is noted that when the sequence number TEK_Seq_No is represented by different number of bit(s), the equation shown in Eq. 5 may be adjusted accordingly and the invention should not be limited thereto. As shown in FIG. 8, in the TEK periodic update procedure, the number TEK_No is updated and the new TEK is derived according to the KEK, the SAID and the TEK_No. Thus, the derived TEKs are unique and satisfy the four requirements as shown in FIG. 5. It should be noted that for simplicity, only the stages and the procedures involved by the proposed method and procedures will be discussed. For persons with ordinary skill in the art, it is easy to derive the non-discussed stages and procedures of FIG. 8, and the invention is not limited thereto. Thus, various alterations and modifications, without departing from the scope and spirit of the invention, may be appropriate. The scope of the present invention shall be defined and protected by the following claims and their equivalents.

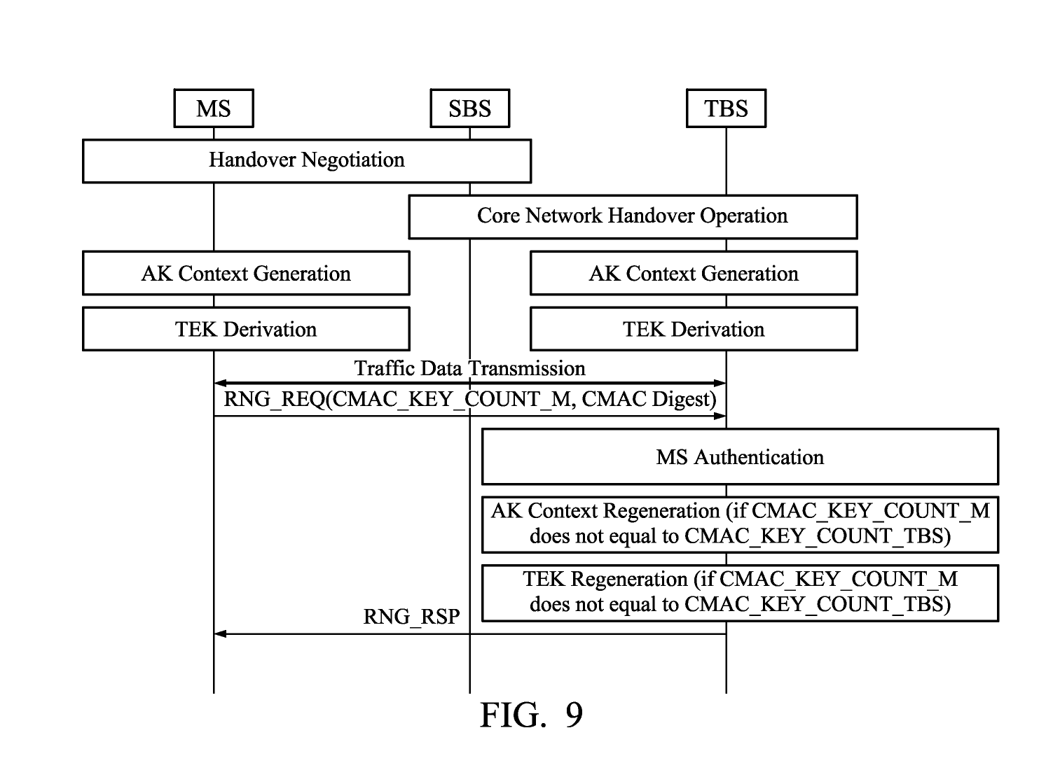

FIG. 9 shows a flow chart of a method for deriving a TEK during a handover procedure according to an embodiment of the invention. Assuming that the MS or the SBS determines to handover the communication services of the MS to the TBS according to some predetermined handover criteria defined by the corresponding specifications, the MS and the SBS may perform handover negotiation to negotiate some essential parameters for performing the following handover operations. The SBS, TBS and the other network devices in the Core Network (such as an Authenticator) may further perform Core Network handover operations. The Authenticator may be one of the network devices in the backbone network (such as the network device 107 shown in FIG. 1) that stores the security-related information and handles the security-related procedures in the communication system. According to an embodiment of the invention, the TBS may obtain the number TEK_No of the MS from the Core Network in the Core Network handover operations. As an example, TBS may obtain the TEK_No included in a TEK context and the count value CMAC_KEY_COUNT associated with the MS from the Authenticator. According to the embodiment of the invention, after the handover negotiation is completed, the MS and TBS may generate AK context, respectively. It should be noted, as those with ordinary skill in the art will readily appreciate, that the AK context may also be generated by the Authenticator or any other network devices in the Core Network (for example, in the Core Network handover operations), and forwarded to the TBS. Thus, the invention should not be limited thereto. According to the embodiment of the invention, the AK context may be generated according to the procedures as illustrated in FIG. 4 and the corresponding paragraphs. After the new AK context is generated, the TEK may be derived by the MS and by the TBS, respectively, according to the TEK derivation functions as shown in Eq. 1 to Eq. 4, or the likes. It is noted that in the embodiment of the invention, the number TEK_No may not be incremented when deriving the TEK in the handover operation. According to another embodiment of the invention, the TEK may also be reset to zero after handover. Although the number TEK_No is not updated in the handover operation, the derived TEK is still different from the previous one because the KEK is different due to the update of the count value CMAC_KEY_COUNT in the handover operation. When the TEKs are derived by the MS and the TBS, the traffic data transmission may begin. Since the traffic data transmission may begin right after the TEKs are derived, a substantially seamless handover may be achieved. The reason why the traffic data transmission may begin right after the TEK derivation is because the essential information to identify the identity of the MS and TBS is already carried in the newly derived TEK, as shown in Eq. 1. Only the correct MS and TBS are able to decrypt the traffic data that has been encrypted by the newly derived TEK.

According to an embodiment of the invention, the MS and the TBS may further confirm the identity of each other in a following network re-entry stage. Because the ranging request message RNG_REQ and the ranging response message RNG_RSP carry plurality of parameters that may be used to authenticate the identity of the MS and the BS, the MS and the TBS may mutually verify the identity of each other. For example, the ranging request message and/or the ranging response message may carry the count value CMAC_KEY_COUNT, MS identity and a CMAC digest generated according to the message authentication keys CMAC_KEY_U and CMAC_KEY_D, where the CMAC digest may be used to prove the integrity and origin of the message. As an example, the CMAC digest may be derived via a Cipher-based Message Authentication Code (CMAC) function that encrypts some predetermined information by using a secret key CMAC_KEY_U/D as the cipher key. The confirmation is required because the handover messages may be lost due to unreliable radio links, or the new TEK may not have been successfully derived due to certain reasons. For example, the TBS may determine that the TEKs generated by the MS and the TBS are inconsistent because the count value CMAC_KEY_COUNT_M carried in the ranging request message is different than the count value CMAC_KEY_COUNT_TBS obtained by the TBS. According to the embodiment of the invention, when the TBS determines that the count values are inconsistent, the AK context may be regenerated according to the count value CMAC_KEY_COUNT_M carried in the ranging request message, and regenerate the TEK according to the new AK context. After the TBS responds by a ranging response message RNG_RSP, the network re-entry may be completed. It should be noted that for simplicity, only the stages and the procedures involved by the proposed method and procedures will be discussed. For persons with ordinary skill in the art, it is easy to derive the non-discussed stages and procedures of FIG. 9, and the invention is not limited thereto. Thus, various alterations and modifications, without departing from the scope and spirit of the invention, may be appropriate. The scope of the present invention shall be defined and protected by the following claims and their equivalents.

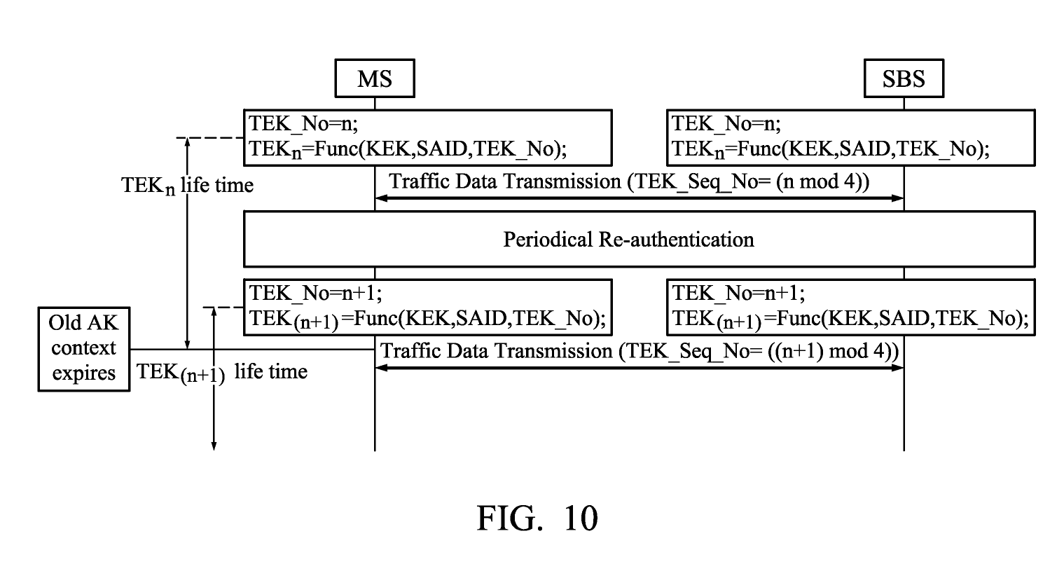

FIG. 10 shows a flow chart of a method for deriving a TEK in a re-authentication procedure according to an embodiment of the invention. The MS and SBS may perform re-authentication when, as an example, the lifetime of the secret key MSK expires. As shown in FIG. 10, in the periodical re-authentication procedure, the number TEK_No may be incremented and the new TEK TEK₍ₙ₊₁₎ is derived according to a new KEK, the SAID and the number TEK_No. The lifetime of the old TEK may end when the old AK context lifetime expires. During the overlap of the time period of the old TEK TEKₙ and the new TEK TEK₍ₙ₊₁₎, both the MS and the SBS may use the older or new TEKs to encrypt the PDUs, and have the ability to decrypt the PDUs by the older or new TEKs. As previously illustrated, the TEK sequence number TEK_Seq_No may be used to differentiate between the new TEK and the older ones. It should be noted that for simplicity, only the stages and the procedures involved by the proposed method and procedures will be discussed. For persons with ordinary skill in the art, it is easy to derive the non-discussed stages and procedures of FIG. 10, and the invention is not limited thereto. Thus, various alterations and modifications, without departing from the scope and spirit of the invention, may be appropriate. The scope of the present invention shall be defined and protected by the following claims and their equivalents. Further, it should be noted that according to another embodiment of the invention, the MS and SBS may also use the TEK of the old AK context in the periodical re-authentication procedure, even if the lifetime of the old AK context expired, and use the new TEK derived according to the new AK context after the lifetime of the TEK of the old AK context expired.

Referring back to FIG. 9, since the count value CMAC_KEY_COUNT is used to generate AK context, the count value CMAC_KEY_COUNT is preferably synchronized at the MS and the TBS sides in advance so as to avoid the CMAC_KEY_COUNT inconsistent errors to occur during the handover operation. According to an embodiment of the invention, the MS may sync the count value CMAC_KEY_COUNT with the TBS in the handover handshake stage. According to an embodiment of the invention, the MS may transmit the count value CMAC_KEY_COUNT_M to any network device in the Core Network, and the network device then relay the count value to the TBS. According to another embodiment of the invention, the MS may transmit the count value CMAC_KEY_COUNT_M to the Authenticator, and then the Authenticator may relay the count value to the TBS.

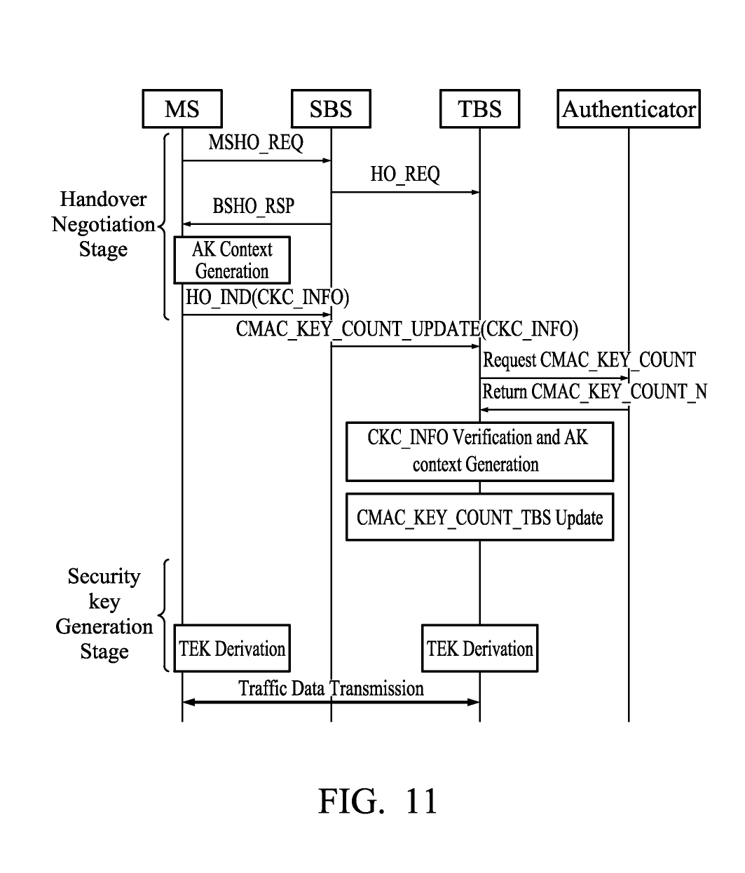

FIG. 11 shows the message flows of handover operation procedures according to an embodiment of the invention. According to the embodiment of the invention, the MS and the SBS performs the handover negotiation via the handshake messages MSHO_REQ, BSHO_RSP and HO_IND in the handover negotiation stage. The MSHO_REQ is a handover request message that informs the BS of the handover request from the MS. The BS responds to handover request via the message BSHO_RSP. The MS further responds to the BS via an indication message HO_IND for the reception of the response message BSHO_RSP. It is noted that the handover operation may also be initiated by the SBS and the invention should not be limited thereto. According to the embodiment of the invention, the MS may generate a new AK context and update the count value CMAC_KEY_COUNT_M for handover during the handover negotiation stage. The updated count value CMAC_KEY_COUNT_M may be transmitted to the SBS via the handover indication message, or transmitted to any other network device in the Core Network via the corresponding messages. The count value CMAC_KEY_COUNT_M may be further relayed by any network devices in the Core Network to finally arrive at the TBS side. As shown in FIG. 11, the SBS relays the information via an indication message CMAC_KEY_COUNT_UPDATE. According to the embodiment of the invention, since the TBS requires some information to confirm the integrity and origin of the CMAC_KEY_COUNT_M, proof of integrity provided by the MS may be carried with the count value CMAC_KEY_COUNT_M. As shown in FIG. 11, the MS may verify to the TBS that the count value CMAC_KEY_COUNT_M has been actually sent by the MS and has not been modified by any third party via the CKC_INFO carried in the handover indication message HO_IND. According to an embodiment of the invention, the CKC_INFO may be generated according to at least one secret key shared with the target base station and at least one information known by the target base station. As an example, the CKC_INFO may be obtained according to:

CKC_INFO=CMAC_KEY_COUNT_M|CKC_Digest Eq. 6,

where the CKC_Digest may be generated according to any secret key or information shared between the MS and the TBS, and the operation “|” means the appending operation. As an example, the CKC_Digest may be derived via a Cipher-based Message Authentication Code (CMAC) function that receives some shared information as the plaintext data and encrypts the information by using a secret key CMAC_KEY_U as the cipher key. The CKC_Digest may be obtained by:

CKC_Digest=CMAC(CMAC_KEY_U, AKID|CMAC_PN|CMAC_KEY_COUNT_M) Eq. 7

where the AKID is the identity of the AK from which the CMAC_KEY_U is derived, and the CMAC_PN (CMAC Packet Number) is a counter for the CMAC_KEY_U which is incremented after each CMAC digest calculation.

After receiving the indication message CMAC_KEY_COUNT_UPDATE carrying information about the count value of the MS, the TBS may check the integrity and the origin of the count value to verify the authenticity of this information, and update the count value CMAC_KEY_COUNT_TBS when the received count value CMAC_KEY_COUNT_M passes the verification. The TBS may acquire the count value CMAC_KEY_COUNT_N from the Core Network, and verify the CKC_Info by the obtained count value CMAC_KEY_COUNT_N. According to an embodiment of the information, the TBS first determines whether the obtained count value CMAC_KEY_COUNT_M is greater than or equal to the count value CMAC_KEY_COUNT_N. Since the count value CMAC_KEY_COUNT_M may be updated every time when the MS plans to perform a handover procedure, the count value CMAC_KEY_COUNT_M should be greater than or equal to the count value CMAC_KEY_COUNT_N uploaded to the Core Network in the initial network entry stage. When the CMAC_KEY_COUNT_M is greater than or equal to the count value CMAC_KEY_COUNT_N, the TBS derives the AK context with the received CMAC_KEY_COUNT_M, and verifies the integrity of the MS by using the key in the AK context. As an example, the TBS verify the CKC_Digest as shown in Eq. 7 by the message authentication key CMAC_KEY_U. The integrity and origin of CMAC_KEY_COUNT is guaranteed when the CKC_Digest can be verified by the key CMAC_KEY_U generated or obtained by the TBS. The TBS updates the count value CMAC_KEY_COUNT_TBS by setting the count value CMAC_KEY_COUNT_TBS=CMAC_KEY_COUNT_M when the integrity of CMAC_KEY_COUNT_M is verified. Since the AK context is generated according to the synchronized count value CMAC_KEY_COUNT_TBS when verifying the CKC_Info, the TBS may derive the TEKs immediately following the verification and update step. The traffic data transmission may begin after the TEKs are respectively derived by the MS and the TBS according to the synchronized CMAC_KEY_COUNT_M and CMAC_KEY_COUNT_TBS. It should be noted, as those with ordinary skill in the art will readily appreciate, that the AK context may also be generated by the Authenticator or any other network devices in the Core Network, and forwarded to the TBS. Thus, the invention should not be limited thereto. Finally, the count value CMAC_KEY_COUNT_M may be updated to the Core Network in the Network re-entry stage (not shown).

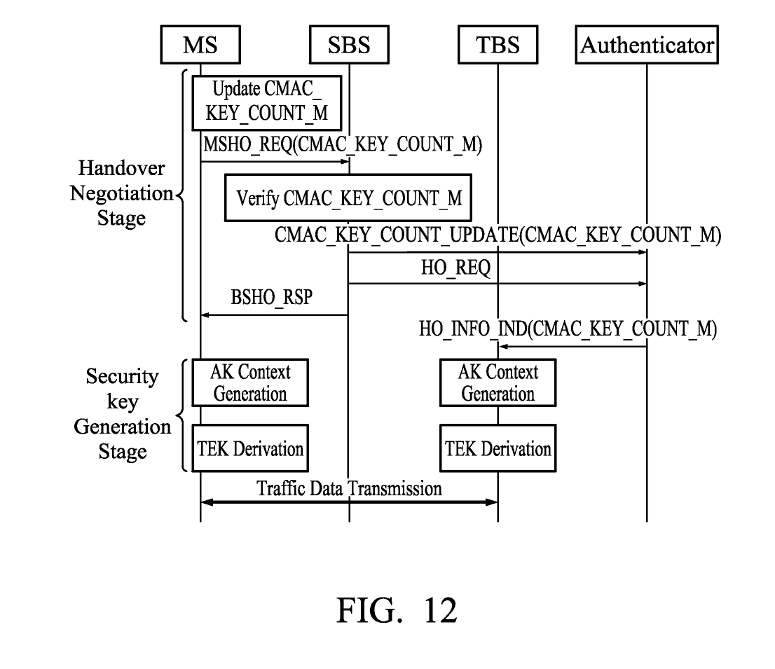

FIG. 12 shows the message flows of handover operation procedures according to another embodiment of the invention. According to the embodiment of the invention, the MS may update the count value CMAC_KEY_COUNT_M for the handover in the handover negotiation stage. The updated count value CMAC_KEY_COUNT_M may be transmitted to the SBS via the handover request message. The SBS may verify the count value CMAC_KEY_COUNT_M by determining whether the count value CMAC_KEY_COUNT_M is greater than or equal to the count value CMAC_KEY_COUNT_SBS maintained by the SBS. When the count value CMAC_KEY_COUNT_M is greater than or equal to the count value CMAC_KEY_COUNT_SBS, the SBS may further transmit the count value CMAC_KEY_COUNT_M to the Authenticator via any message. As an example, the SBS transmits the count value CMAC_KEY_COUNT_M via an indication message CMAC_KEY_COUNT_UPDATE to the Authenticator as shown in FIG. 12. The Authenticator may next forward the count value CMAC_KEY_COUNT_M to the TBS via, as an example, a HO_INFO_IND message. According to the embodiment of the invention, since the TBS trusts the Authenticator, the MS doesn't need to transmit any additional information to verify integrity. After the TBS receives the count value CMAC_KEY_COUNT_M of the MS, the TBS may generate the AK context and derive the TEKs according to the count value CMAC_KEY_COUNT_M. The traffic data transmission may begin after the TEKs are respectively derived by the MS and the TBS according to the synchronized count values. It should be noted, as those with ordinary skill in the art will readily appreciate, that the AK context may also be generated by the Authenticator or any other network devices in the Core Network, and forwarded to the TBS. Thus, the invention should not be limited thereto. Finally, the count value CMAC_KEY_COUNT_M may be updated to the Core Network in the Network re-entry stage (not shown). In the embodiments of the invention, since the count value CMAC_KEY_COUNT_TBS has been the synchronized with the count value CMAC_KEY_COUNT_M in advance, the TEKs derived by the MS and the TBS are consistent and the traffic data can be decrypted and decoded correctly.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A mobile station in a wireless communication network, comprising:
one or more radio transceiver module; and
a processor generating an Authorization Key (AK) context comprising at least one secret key shared with a base station, transmitting at least one association negotiation message via the radio transceiver module to the base station to obtain an association of a service flow established by the base station, and generating at least one Traffic Encryption Key (TEK) according to the secret key and an identifier associated with the association,
wherein the service flow is established for traffic data transmission with the base station and the TEK is a secret key shared with the base station for encrypting and decrypting the traffic data.

2. The mobile station as claimed in claim 1, wherein the processor further obtains a number associated with the TEK to distinguish between different generations of the TEK, and generates the TEK according to the secret key, the identifier and the number after initial network entry and network reentry.

3. The mobile station as claimed in claim 1, wherein the secret key is generated according to a count value shared with the base station to distinguish between different generations of message authentication keys in the AK context.

4. The mobile station as claimed in claim 1, wherein the association is a Security Association (SA) describing at least one cryptographic algorithm used to encrypt or decrypt the traffic data.

5. The mobile station as claimed in claim 2, wherein the processor further increases the value of the number and updates the TEK by generating at least one new TEK according to the secret key, the identifier and the number, periodically.

6. The mobile station as claimed in claim 2, wherein the processor further increases the value of the number and updates the TEK by generating at least one new TEK according to the secret key, the identifier and the number in a re-authentication procedure.

7. The mobile station as claimed in claim 2, wherein the processor further resets the value of the number to zero and updates the TEK by generating at least one new TEK according to the secret key, the identifier and the number.

8. A method for generating at least one Traffic Encryption Key (TEK) for a mobile station and a base station in a wireless communication network, comprising:
generating an Authorization Key (AK) context, wherein the AK context comprises at least one secret key shared between the mobile station and base station for protecting at least one message transmitted therebetween;
obtaining an association of a service flow established between the mobile station and base station to transmit traffic data therebetween, wherein the association is identified by an identifier;
obtaining a number associated with the TEK to be generated; and
generating the TEK according to the secret key, the identifier and the number via a predetermined function, wherein the TEK is a secret key shared between the mobile station and the base station for encrypting or decrypting the traffic data.

9. The method as claimed in claim 8, wherein the secret key is generated according to a count value shared between the mobile station and the base station to distinguish between different generations of message authentication keys in the AK context.

10. The method as claimed in claim 8, wherein the association is a Security Association (SA) describing at least one cryptographic algorithm used to encrypt or decrypt the traffic data.

11. The method as claimed in claim 8, wherein the number is used to distinguish between different generations of the TEK.

12. The method as claimed in claim 8, wherein the predetermined function is a cryptographic function that receives the identifier and the number as plaintext data, and encrypts the plaintext data by using the secret key.

13. The method as claimed in claim 8, further comprising:
increasing the number in a TEK periodic update procedure; and
generating at least one new TEK according to the secret key, the identifier and the number in the TEK periodic update procedure.

14. The method as claimed in claim 8, further comprising:
increasing the number in a re-authentication procedure of the mobile station and the base station; and
generating at least one new TEK according to the secret key, the identifier and the number in the re-authentication procedure.

15. The method as claimed in claim 8, further comprising:
resetting the number to zero during handover; and
generating at least one new TEK according to the secret key, the identifier and the number during handover.

16. The method as claimed in claim 8, further comprising:
generating at least one new TEK according to the secret key, the identifier and the number, without being incremented, during handover.

17. A mobile station in a wireless communication network, comprising:
a radio transceiver module; and
a processor performing handover negotiation with a serving base station so as to handover communication services to a target base station by transmitting and receiving a plurality of handover negotiation messages via the radio transceiver module, updating a count value, generating an Authorization Key (AK) context comprising a plurality of secret keys shared with the target base station for protecting messages to be transmitted to the target base station, and transmitting the count value to at least one network device in the wireless communication network via the radio transceiver module,
wherein the count value is used in AK context generation and capable of distinguishing between different generations of the AK context, and is relayed to the target base station via the network device.

18. The mobile station as claimed in claim 17, wherein the processor transmits the count value to an authenticator handling security-related procedures in the wireless communication network so as to relay the count value via the authenticator to the target base station.

19. The mobile station as claimed in claim 17, wherein the processor further generates proof data to prove integrity of the count value and transmits the proof data with the count value to the network device so as to relay the count value and the proof data via the network device to the target base station, wherein the proof data is generated according to at least one secret key shared with the target base station and at least one information known by the target base station.

20. The mobile station as claimed in claim 19, wherein the proof data is generated by using the secret key in the AK context as a shared key and the count value as the protected information

21. The mobile station as claimed in claim 17, wherein the processor generates one secret key of the AK context according to the count value, and derives a Traffic Encryption Key (TEK) according to the secret key, wherein the TEK is a key shared with the target base station for encrypting or decrypting traffic data transmitted therebetween.

22. A base station in a wireless communication network, comprising:
one or more radio transceiver module; and
a processor generating an Authorization Key (AK) context comprising at least one secret key shared with a mobile station, establishing an association of a service flow, obtaining a number, and generating at least one Traffic Encryption Key (TEK) according to the secret key, the number and an identifier associated with the association,
wherein the service flow is established for traffic data transmission and reception with the mobile station via the radio transceiver, the number is associated with the TEK to distinguish between different generations of the TEK, and the TEK is a secret key shared with the mobile station for encrypting and/or decrypting the traffic data.
